(19) United States
(12) Patent Application Publication
(10) Pub. No.: US 2005/0020360 A1
(43) Pub. Date: Jan. 27, 2005

(54) Game machine

(76) Inventor: Toshiyuki Hosaka, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/870,681

(22) Filed: Jun. 17, 2004

(30) Foreign Application Priority Data
Jun. 18, 2003 (JP) 2003/173342
Jan. 21, 2004 (JP) 2004/013217

(51) Int. Cl. G06F 17/00

(52) U.S. Cl. 463/31

(57) ABSTRACT

A game machine is provided that includes a projector equipped with a light source that emits light for displaying an image and a light converting optical system. The light converting optical system includes a conversion means that converts the light emitted from the light source to approximately parallel light and a light modulating element that modulates the converted approximately parallel light. The projector displays the image by projecting the modulated light from a rear surface of a display unit. The light source is equipped with a solid-state light source that emits the light for displaying the image.

### RELATED APPLICATIONS

This application claims priority to Japanese Patent Application Nos. 2003-173342 filed Jun. 18, 2003 and 2004-013217 filed Jan. 21, 2004 which are hereby expressly incorporated by reference herein in their entirety.

### BACKGROUND OF THE INVENTION

1. Field of the Invention

This invention relates to a game machine equipped with a projector that displays images by converting light emitted from a light source to approximately parallel light, modulating the approximately parallel light, and projecting the light from a rear surface of a display unit.

2. Description of the Related Art

As one example of a pachinko machine (a Japanese bouncing ball game machine that is one example of a “game machine” for the present invention) equipped with the above kind of a display apparatus, Japanese Laid-Open Utility Model H07-24381 discloses a pachinko machine that uses a rear-projection type projector (display apparatus, 4) to project an image onto a transmissive image display unit (2) on a front panel (1). In this case, the projector is constructed so as to include a liquid crystal display element and a light source, with a projection lens (5) being disposed between the projector and the front panel. In this pachinko machine, the projector first modulates the light emitted from the light source by having the light pass through the liquid crystal display element. Next, the projection lens magnifier and projects the light modulated by the projector onto the transmissive image display unit on the front panel. By doing so, an image is displayed on the transmissive image display unit. In this type of pachinko machine, a high pressure mercury lamp that can emit a large amount of light is normally used as the light source. Accordingly, a bright image can be displayed.

However, by investigating the pachinko machine described above, the present inventors discovered the following problems. In the above pachinko machine, images are displayed by modulating and then projecting light from a high pressure mercury lamp. In this case, if the high pressure mercury lamp blows during a game, the image stops being displayed, so that the game has a problem and inevitably needs to be interrupted. Accordingly, if the high pressure mercury lamp blows during a jackpot, for example, interrupting the game can result in the jackpot state being lost and in the player missing out on a large win. To avoid this kind of situation, the high pressure mercury lamp provided in this kind of pachinko machine is replaced regularly before the lamp blows (that is, before the total possible illumination time for the lamp has been reached). However, since high pressure mercury lamps are expensive and have a relatively short life (total possible illumination time), frequently replacing the high pressure mercury lamp involves a high replacement cost. In addition, since high pressure mercury lamps consume a large amount of power, the electrical cost of such pachinko machines is also high. Accordingly, due to such costs, there has been the problem that the running cost of conventional pachinko machines has been high.

Also, high pressure mercury lamps generate a large amount of heat during illumination. For this reason, to prevent the control device and the like in such pachinko machines from being affected by such heat, it is necessary to provide a heat dissipation device, such as a cooling fan, to expel the generated heat to the outside of the pachinko machine and outside an “island” of pachinko machines (an area in which a plurality of pachinko machines are disposed next to one another). Accordingly, with conventional pachinko machines, there is the further problem of the heat emitted from the respective pachinko machines causing environmental deterioration in a pachinko hall.

In addition, high pressure mercury lamps take a relatively long time to reach a normal operating state (a state where the emitted amount of light reaches a predetermined amount) after the power is turned on. Accordingly, with a conventional pachinko machine, if the lamp blows during a game, for example, even if the lamp can be replaced in a short time, the image will be dark for some time following the turning on of the power, so that there is the problem that it is not possible to immediately resume the game and the game ends up being interrupted for a long time. In addition, high pressure mercury lamps need to be cooled down for a relatively long period after illumination to prevent the lamps from blowing. Accordingly, with a conventional pachinko machine, even when an inspection is carried out, for example, which may not take very long, after turning the power off, it is necessary to wait for the lamps to cool down before turning the power back on, so that there is the further problem of game being interrupted for a long time.

### SUMMARY OF THE INVENTION

The present invention was conceived in view of the above problems, and it is a principal object of the present invention to provide a game machine that has a reduced running cost, generates less heat, and can also reduce the length of interruptions due to lamps blowing, inspections, and the like.

A game machine according to the present invention includes a projector equipped with a light source that emits light for displaying an image, and a light converting optical system including a conversion means that converts the light emitted from the light source to approximately parallel light and a light modulating element that modulates the converted approximately parallel light, the projector displaying the image by projecting the modulated light from a rear surface of a display unit, wherein the light source is equipped with a solid-state light source that emits the light for displaying the image.

In this game machine, the projector is includes a solid-state light source as the light source. Since the operating life of a solid-state light source is long, images can be displayed for a long period using the solid-state light source. This means that compared to a high pressure mercury lamp that is used as a light source in a conventional game machine, it is possible to considerably lower the replacement frequency of the solid-state light source used as the light source. Solid-state light sources are much cheaper than high pressure mercury lamps, so that the purchase costs of the replacement light sources can also be considerably reduced. Accordingly, the replacement cost of the light source can be considerably reduced due to the reductions in replacement frequency and purchase cost. Also, since solid-state light sources have low power consumption, a corresponding reduction can be made in the amount of power used by a game machine. As a result, it is possible to considerably reduce the running cost of the game machine. Since solid-state light sources generate much less heat than high pressure mercury lamps, it is also possible to considerably reduce the amount of heat emissions to the outside of the game machine. Accordingly, it is possible to prevent environmental deterioration in a pachinko hall due to a rise in temperature in the periphery area of the game machine.

In addition, since solid-state light sources reach a normal operating state shortly after the power is turned on, even if the solid-state light source blows during a game, for example, after the solid-state light source is replaced and the power is turned back on, images can be displayed brightly in a short time. Also, after being extinguished, solid-state light sources can be immediately turned back on without having to cool down, so that even if the power is turned off during a game for an inspection, for example, after the inspection is complete, the power can be turned back on immediately. Accordingly it is possible to considerably reduce the length of interruptions to games due to lamps blowing, inspections, and the like.

In this case, the solid-state light sources should preferably be composed of at least one red light emitting diode that emits red light, at least one green light emitting diode that emits green light, and at least one blue light emitting diode that emits blue light. With the above construction, it is possible to adjust the current and voltage for light emission separately for each type (color) of LED, so that it is possible to easily change the balance in the amounts of red light, green light, and blue light. As a result, the hues (colors) of the image can be easily and reliably changed.

It is also preferable for the light modulating optical system to be composed of a three-plate type modulating optical system equipped with, as the light modulating element, a red light modulating element that separately modulates the red light, a green light modulating element that separately modulates the green light, and a blue light modulating element that separately modulates the blue light. With this construction, it is possible to modulate light using a larger number (around triple the number, for example) of pixels than a single-plate type modulating optical system that includes only one light modulating element, for example, and a corresponding improvement can be made in the image quality of the displayed image.

It is also preferable for the light modulating optical system to be a single-plate type modulating optical system equipped with, as the light modulating element, a single light modulating element that modulates the red light, the green light, and the blue light. With this construction, images can be displayed in color without providing a plurality of expensive light modulating elements, so that a projector and a game machine that can display images in color can be constructed at low cost.

It is also preferable for the solid-state light source to be composed of at least one white light emitting diode that emits white light, the projector to be equipped with a light separating optical system that separates the white light into red light, green light, and blue light, and the light modulating optical system to be composed of a three-plate type modulating optical system equipped with, as the light modulating element, a red light modulating element that separately modulates the red light, a green light modulating element that separately modulates the green light, and a blue light modulating element that separately modulates the blue light. With the above construction, only one type of LED composes the light source, so that compared to a light source equipped with a plurality of types of LEDs, it is easy to control the emitted amount of light. Accordingly, it is possible to easily adjust the brightness, for example, of the image. Also, since the red light, the green light, and the blue light are separately modulated by the three light modulating elements, it is possible to display images with high image quality.

It is also preferable for the solid-state light source to be composed of at least one white light emitting diode that emits white light, the projector to be equipped with a light separating optical system that separates the white light into red light, green light, and blue light, and the light modulating optical system to be composed of a single-plate type modulating optical system equipped with, as the light modulating element, a single light modulating element that modulates the red light, the green light, and the blue light. With the above construction, it is possible to display images in color using a light source that includes only LEDs that emit white light and a single light modulating element. This means that a projector and a game machine can be provided at low cost.

It is also preferable for the conversion means to be composed of at least one of a lens array, a collimator lens, and a rod integrator. With this construction, light emitted from the solid-state light source is converted to parallel light with high efficiency, so that the length of the optical path from the solid-state light source to the light modulating element can be made shorter. This means that the light modulating optical system and the projector can be made small, which makes it possible to make the case (housing) of the game machine slim line, for example.

The projector should preferably be equipped with a heat radiating plate that radiates heat generated by the solid-state light source. With the above construction, it is possible to efficiently radiate heat generated by the solid-state light source, so that such heat can be prevented from affecting the solid-state light source and its periphery.

The projector should also preferably be equipped with an air circulating fan that cools the solid-state light source. With the above construction, heat generated by the solid-state light source can be forcibly dissipated. Accordingly, the solid-state light source and its periphery can be efficiently cooled, so that heat can be reliably prevented from affecting the solid-state light source and its periphery.

### BRIEF DESCRIPTION OF THE DRAWINGS

These and other objects and features of the present invention will be explained in more detail below with reference to the attached drawings, wherein:

FIG. 1 is a front elevation schematically showing the construction of a pachinko machine;

FIG. 2 is a block diagram showing the construction of the pachinko machine;

FIG. 3 is a side-surface cross-sectional view schematically showing the construction of a pachinko machine;

FIG. 4 is a cross-sectional view showing the construction of the projector;

FIG. 5 is a cross-sectional view showing the construction of another pachinko machine (another projector);

FIG. 6 is a cross-sectional view showing the construction of another pachinko machine (another projector);

FIG. 7 is a cross-sectional view showing the construction of another pachinko machine (another projector);

FIG. 8 is a front elevation schematically showing the construction of a slot machine;

FIG. 9 is a side-surface cross-sectional view schematically showing the construction of a slot machine;

FIG. 10 is a front elevation schematically showing the construction of a pinball machine; and

FIG. 11 is a side-surface cross-sectional view schematically showing the construction of a pinball machine.

### DESCRIPTION OF THE PREFERRED EMBODIMENTS

Hereafter, preferred embodiments of a game machine according to the present invention will be described with reference to the attached drawings.

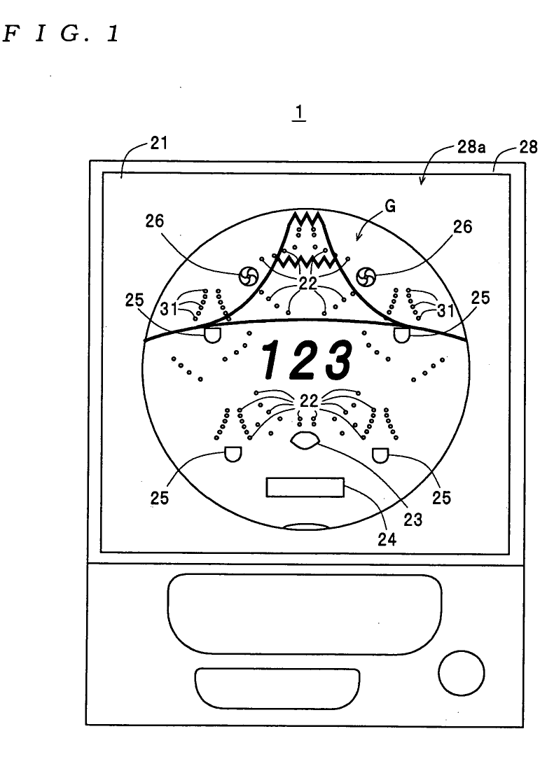

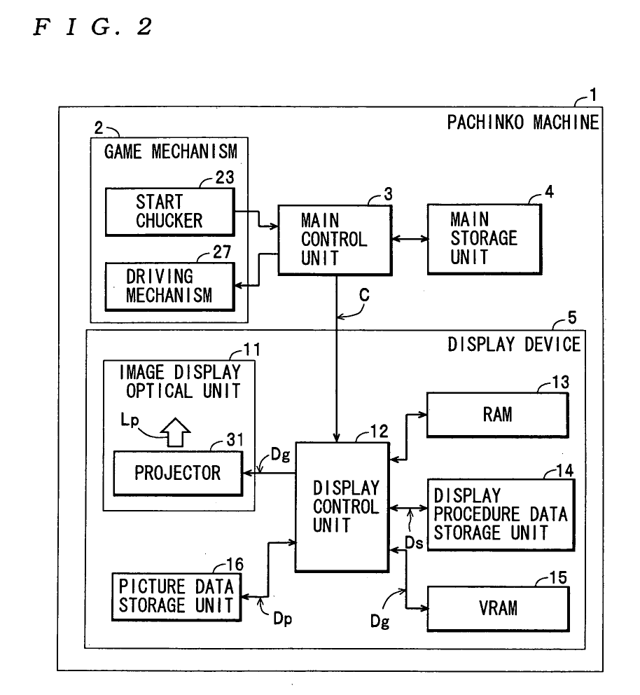

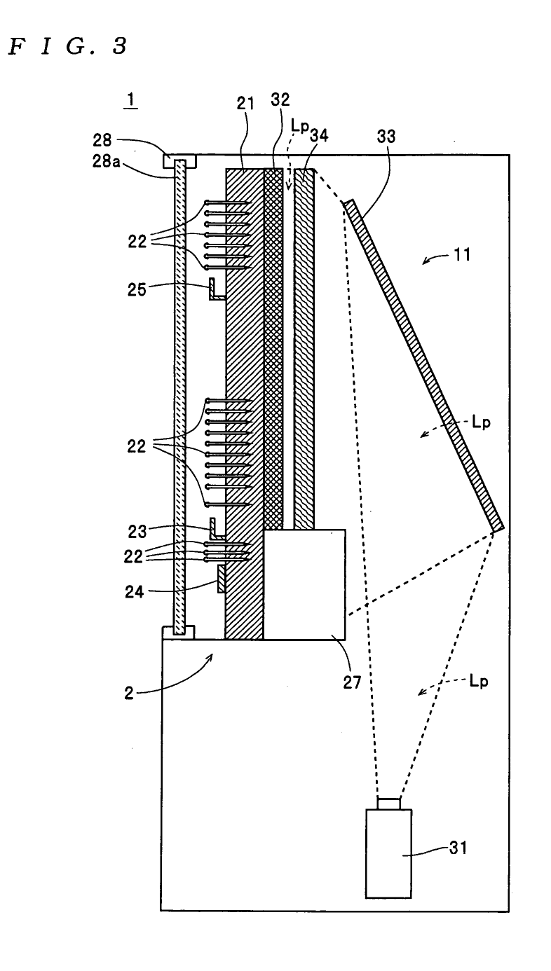

First, the construction of a pachinko machine (game machine) 1 will be described with reference to the drawings. The pachinko machine 1 shown in FIG. 1 is a “seven machine”-type pachinko machine, for example, where a jackpot can occur depending on a prize draw, and is constructed so as to be able to display an image G (for example, the scenery, Mt. Fuji, and the numerals “123” shown in FIG. 1) produced by light projected from a rear surface side of a game board 21 that also functions as a display unit of the present invention. More specifically, as shown in FIG. 2, the pachinko machine 1 is composed of a game mechanism 2, a main control unit 3, a main storage unit 4, and a display device 5. As shown in FIG. 3, the game mechanism 2 includes the game board 21 and a driving mechanism 27. The game board 21 is formed of a light transmitting resin (as one example, polycarbonate) and when viewed from the front, has an overall form in the shape of a rectangular plate, for example. As shown in FIGS. 1 and 3, the game board 21 is constructed with a plurality of nails 22, 22, . . . , a start chucker 23, a big hit prize hole (“attacker”) 24, hit prize holes 25, 25, windmills 26, 26, and the like disposed upon it. It should be noted that a door 28 in which a clear glass pane 28a has been fitted is attached onto the front of the game board 21. As shown in FIG. 3, the driving mechanism 27 is attached to a rear surface of the game board 21, and pays out (discharges) game balls and opens and closes the big hit prize hole 24 in accordance with instructions from the main control unit 3.

The main control unit 3 carries out overall control over the driving mechanism 27 and the display device 5, and also carries out a random selection when a game ball has entered the start chucker 23. The main control unit 3 also outputs a command C when there is a change in the game state, such as when a prize draw starts or when the player hits the jackpot, and thereby has the display device 5 carry out an image display process that has various types of image G displayed. In this case, the main control unit 3 includes an indication of a required display procedure data Ds (this is described later) for displaying the image G in the command C that is outputted. The main storage unit 4 stores an operation program of the main control unit 3, and the like.

As shown in FIG. 2, the display device 5 includes an image display optical unit 11, a display control unit 12, a RAM 13, a display procedure data storage unit 14, a VRAM 15, and a pattern data storage unit 16. As shown in FIG. 3, the image display optical unit 11 includes a projector 31, a screen film 32, a mirror 33, and a Fresnel lens 34.

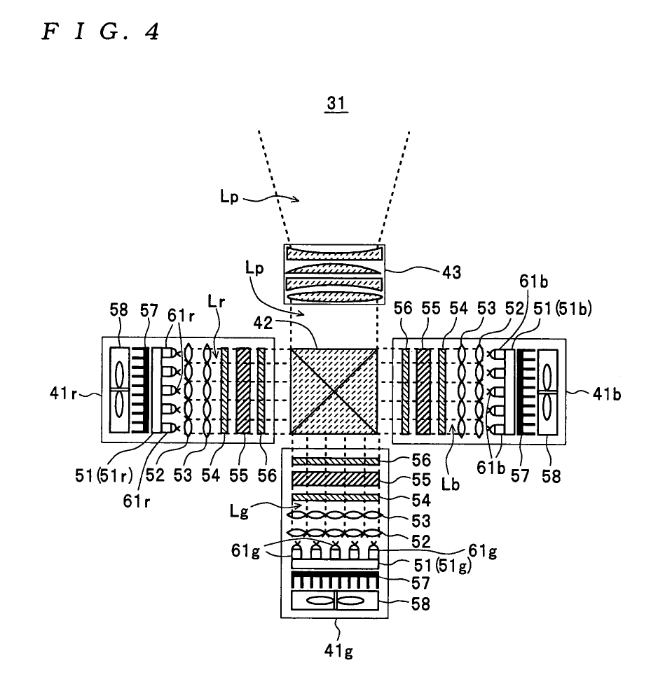

Based on display image data Dg outputted by the display control unit 12, the projector 31 emits modulated projection light Lp. In this case, the projector 31 is a “three-plate type projector” (i.e., a projector equipped with a three-plate type modulating optical system) equipped with three LCD light valves 55, described later, and as shown in FIG. 4, is composed of light modulating units 41r, 41g, 41b (referred to simply as “light modulating units 41” when no distinction is required), a prism 42, and a projector lens 43. Each light modulating unit 41 includes an LED unit 51, lens arrays 52, 53, an incident-side polarizing plate 54, an LCD light valve 55, an irradiation-side polarizing plate 56, a heat sink 57, and a cooling fan 58. In this case, the lens arrays 52, 53, the incident-side polarizing plate 54, the LCD light valve 55, and the irradiation-side polarizing plate 56 compose a light modulating optical system for the present invention.

The LED unit 51 corresponds to the light source for the present invention and is composed of a plurality of LEDs (Light Emitting Diodes-one example of a solid-state light source for the present invention) arranged on a substrate in a matrix pattern, for example. In this case, as shown in FIG. 4, red LEDs 61r, 61r, . . . that emit red light Lr are disposed in the LED unit 51 (hereinafter also referred to as the “LED unit 51r”) of the light modulating unit 41r. In the same way, green LEDs 61g, 61g, . . . that emit green light Lg are disposed in the LED unit 51 (hereinafter also referred to as the “LED unit 51g”) of the light modulating unit 41g. Also, blue LEDs 61b, 61b, . . . that emit blue light Lb (hereinafter, the red light Lr, the green light Lg, and the blue light Lb are referred to simply as “light L” when no distinction is required) are disposed in the LED unit 51 (hereinafter also referred to as the “LED unit 51b”) of the light modulating unit 41b. Hereinafter, when no distinction is required, the red LEDs 61r, the green LEDs 61g, and the blue LEDs 61b are referred to simply as the “LEDs 61.”

The lens arrays 52, 53 correspond to the conversion means for the present invention, and are constructed of a plurality of integrally formed small lenses arranged in a matrix pattern, for example. The lens arrays 52, 53 are disposed on the emission side for the light L of the LED unit 51 and convert the light L (diverge light) emitted by the LED unit 51 to parallel light. The lens arrays 52, 53 function as optical integrators that irradiate the entire LCD light valve 55 (the incident-side polarizing plate 54) approximately evenly (i.e., with a uniform degree of illumination) with the converted light L. The incident-side polarizing plate 54 is formed with approximately the same size as the LCD light valve 55 and is disposed on the side of the LCD light valve 55 on which the light L is incident. In this case, the incident-side polarizing plate 54 linearly polarizes the light L that has been converted to parallel light by the lens arrays 52, 53. The LCD light valve 55 corresponds to a light modulating element for the present invention, and transmits and modulates, based on the display image data Dg, the light L that has been linearly polarized by the incident-side polarizing plate 54. The irradiation-side polarizing plate 56 emits and aligns the light L that has been modulated by the LCD light valve 55 in the amplitude direction. The heat sink (heat dissipation plates) 57 is constructed of a plurality of thin metal plates, is disposed in tight contact with the substrate of the LED unit 51, and dissipates heat generated by the LED unit 51 (the LEDs 61). The cooling fan 58 is disposed near the heat sink 57 and cools the heat sink 57 by circulating air in a periphery of the heat sink 57 (in a periphery of the LED unit 51).

The prism 42 combines the light L (the red light Lr, the green light Lg, and the blue light Lb) modulated by the respective LCD light valves 55, 55, 55 and emits the projection light Lp for displaying the image G in color. The projector lens 43 magnifies the projection light Lp emitted by the prism 42. In this case, the projector 31 is disposed at a position inside the pachinko machine 1, for example, near the bottom surface, and projects the projection light Lp upwards, for example.

As shown in FIG. 3, the screen film 32 is fixed onto the rear surface of the game board 21. In this case, as one example the screen film 32 receives the projection light Lp emitted from the projector 31 and disperses the light to form the image G. The mirror 33 is disposed on a rear surface side of the game board 21 and reflects the projection light Lp emitted by the projector 31 towards the screen film 32. The Fresnel lens 34 is disposed between the mirror 33 and the screen film 32 and converts the projection light Lp, which has been projected by the projector 31 and reflected by the mirror 33, to parallel light projected onto the screen film 32.

The display control unit 12 carries out an image display process in accordance with the command C outputted by the main control unit 3 to generate the display image data Dg for displaying various types of image G and outputs the display image data Dg to the projector 31. In this case, the display image data Dg is composed of red image data, green image data, and blue image data corresponding to images produced by separating the image G into the respective color components red, green, and blue. The RAM 13 temporarily stores various kinds of data generated by the display control unit 12. The display procedure data storage unit 14 stores display procedure data Ds, in which information such as indications of pictures used in the image G and a display position and size of the image G are written. The VRAM 15 stores the display image data Dg generated when an image is virtually drawn by the display control unit 12. The picture data storage unit 16 stores various Pattern data Dp (pattern data for scenery, Mt. Fuji, numerals, and the like) for generating the display image data Dg.

Next, the overall operation of the pachinko machine 1 will be described with reference to the drawings. When the power is turned on, the main control unit 3 in the pachinko machine 1 first outputs a command C that indicates the display procedure data Ds for displaying the image G shown in FIG. 1, for example. In response to this, the display control unit 12 checks the content of the command C and executes the image display process. In this image display process, the display control unit 12 reads the display procedure data Ds indicated by the command C from the display procedure data storage unit 14. Next, in accordance with the procedure of the read display procedure data Ds, the display control unit 12 reads the pattern data Dp, Dp, . . . required for generating the display image data Dg for displaying the image G from the pattern data storage unit 16. Next, the display control unit 12 virtually draws patterns corresponding to the read pattern data Dp, Dp, . . . on a virtual screen in the VRAM 15 (i.e., the display control unit 12 stores the pictures in the VRAM 15), thereby generating the display image data Dg in the VRAM 15. After this, the display control unit 12 outputs the display image data Dg in the VRAM 15 to the projector 31.

On the other hand, in the projector 31, when the power is turned on, as shown in FIG. 4, the respective LEDs 61r, 61g, 61b of the LED units 51r, 51g, 51b are lit so that the red light Lr, the green light Lg, and the blue light Lb are emitted. At this time, the LEDs 61 reach a normal operating state shortly after the power is turned on and therefore emit a sufficient amount of light L for displaying the image G brightly. Also, when the power is turned on, the respective cooling fans 58, 58, 58 are operated and respectively cool the heat sinks 57. At this time, the heat generated by the LED unit 51 (the LEDs 61) is radiated to the periphery by the heat sink 57, and air is circulated by the cooling fan 58 to further dissipate such heat to the periphery. Accordingly, the LED unit 51 (the LEDs 61) and the periphery are efficiently cooled, so that the generated heat is reliably prevented from affecting the LED unit 51 (the LEDs 61) and the periphery. In this case, relatively little heat is generated by the LEDs 61, so that the amount of heat dissipated to the outside of the pachinko machine 1 is suppressed, and as a result, a rise in temperature in the periphery of the pachinko machine 1 is suppressed.

Also, the lens arrays 52, 53 convert the light L emitted from the LED unit 51 to parallel light and irradiate the entire incident-side polarizing plate 54 with an approximately even degree of illumination. Next, the incident-side polarizing plate 54 linearly polarizes the light L converted to parallel light by the lens arrays 52, 53. Next, the LCD light valve 55 modulates the light L, which has been linearly polarized by the incident-side polarizing plate 54, based on the display image data Dg. In this case, the LCD light valve 55 of the light modulating unit 41r modulates the red light Lr based on the red image data in the display image data Dg. In the same way, the LCD light valve 55 of the light modulating unit 41g modulates the green light Lg based on the green image data in the display image data Dg, and the LCD light valve 55 of the light modulating unit 41b modulates the blue light Lb based on the blue image data in the display image data Dg. Next, the irradiation-side polarizing plate 56 aligns the light L that has been modulated by the LCD light valve 55 in the amplitude direction and emits the light L.

Next, the prism 42 combines the red light Lr, the green light Lg, and the blue light Lb that have been modulated by the respective LCD light valves 55, 55, 55 and emits the projection light Lp. Next, the projector lens 43 magnifies the projection light Lp emitted by the prism 42. After this, the projected light Lp magnified by the projector lens 43 is reflected by the mirror 33, is converted to parallel light by the Fresnel lens 34, and is projected onto the screen film 32. By doing so, the image G formed on the screen film 32 is displayed in color on the game board 21.

After this, a game is commenced and when a game ball enters the big hit prize hole 25 and a prize draw is conducted or when a jackpot results from such a prize draw, in the same way as the operation described above, the main control unit 3 outputs a command C indicating the display procedure data Ds for displaying an image G for a prize draw or an image G for a jackpot performance, and the display control unit 12 carries out the image display process and thereby outputs the display image data Dg. On the other hand, in the same way as the operation described above, the projector 31 emits the projection light Lp for displaying the image G for a prize draw or the image G for a jackpot payout performance based on the display image data Dg. By doing so, the image G for a prize draw or the image G for a jackpot performance is displayed on the game board 21. In this case, since the LEDs 61 have a long operational life, it is possible to have the LEDs 61 emit light for a long time. This means that it is possible to sufficiently suppress the frequency with which the LEDs 61 are replaced.

In this way, according to this pachinko machine 1, the projector 31 is equipped with the LED units 51, in which the LEDs 61 are disposed, as the light source, and since the LEDs 61 have a long operational life, the image G can be displayed throughout the long life of the LEDs 61. This means that compared to a conventional pachinko machine in which a high pressure mercury lamp is used as the light source, it is possible to sufficiently suppress the frequency with which the LEDs 61 are replaced. LEDs 61 are also considerably cheaper than high pressure mercury lamps, so that the purchasing cost of the replacement parts (LEDs 61) can be sufficiently reduced. Accordingly, due to the reduced frequency of replacement and reduced purchasing cost, it is possible to considerably reduce the replacement cost of the LEDs 61. In addition, LEDs 61 have lower power consumption than high pressure mercury lamps, so that the amount of power used by the pachinko machine 1 can be reduced by that amount. As a result, it is possible to sufficiently reduce the running cost of the pachinko machine 1. Also, since LEDs generate considerably less heat than high pressure mercury lamps, the amount of heat dissipated to the outside the pachinko machine 1 can be considerably reduced, so that it is possible to prevent environmental deterioration in a pachinko hall due to a rise in peripheral temperature for the pachinko machine 1.

In addition, since the LEDs 61 reach a normal operational state shortly after the power is turned on, even if the LEDs blow during a game, for example, if the LEDs 61 are replaced and the power is turned back on, it is possible to display the image G brightly in a short time. Also, the LEDs 61 can be lit immediately after being extinguished without having to cool down, so that even if the power is turned off during a game for an inspection, for example, the power can be turned back on as soon as the inspection has ended. Accordingly, it is possible to considerably reduce the length of interruptions to games caused by lamps blowing, inspections, and the like.

Also, the projector 31 is equipped with red LEDs 61r that emit the red light Lr, green LEDs 61g that emit the green light Lg, and blue LEDs 61b that emit the blue light Lb, so that the current and voltage for emitting light can be adjusted separately for each kind of LED 61. Accordingly, it is possible to easily adjust the balance between the amounts of red light Lr, green light Lg, and blue light Lb, and as a result, it is possible to easily and reliably change the hues (colors) of the image G.

By constructing the projector 31 with three LCD light valves 55, 55, 55 that modulate light separately for the red light Lr, the green light Lg, and the blue light Lb, it is possible to modulate the light L using a larger number (around triple the number, for example) of pixels than a single-plate type modulating optical system that includes only one LCD light valve, for example, and a corresponding improvement can be made in the image quality of the displayed image G.

In addition, by providing the lens arrays 52, 53 that convert the light L emitted by the LED unit 51 to parallel light, since the light L is converted to parallel light with high efficiency by the lens arrays 52, 53, the optical path from the LED unit 51 to the LCD light valve 55 (the incident-side polarizing plate 54) can be made shorter. Accordingly, the light modulating unit 41 and the projector 31 can be made smaller, which makes it possible to make the case (housing) of the pachinko machine 1 slim line, for example.

Also, by providing the heat sinks 57, the heat generated by the LED units 51 (the LEDs 61) can be efficiently radiated, so that the heat can be prevented from affecting the LED units 51 and their peripheries.

By providing the cooling fans 58, air can be circulated in the peripheries of the LED units 51, so that the heat generated by the LED units 51 (LEDs 61) can be forcibly dissipated, so that the LED units 51 and their peripheries can be efficiently cooled, which makes it possible to reliably prevent the heat from affecting the LED units 51 and their peripheries.

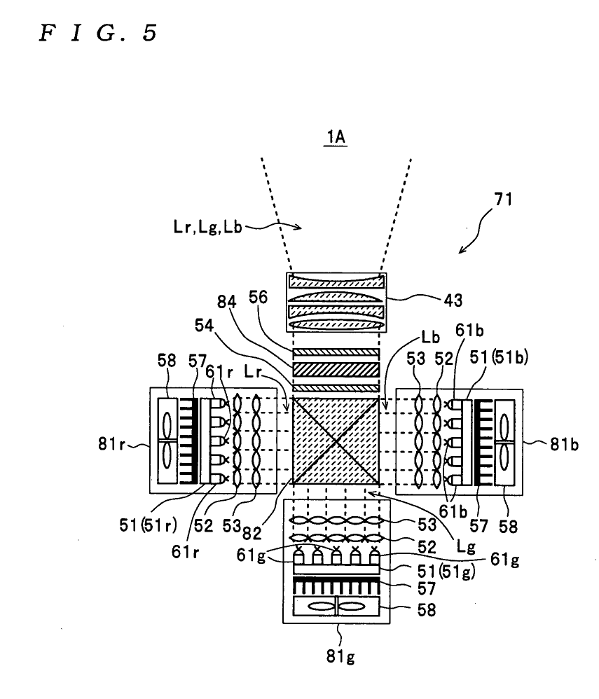

Next, the construction and overall operation of a pachinko machine 1A according to another embodiment of the present invention will be described with reference to the drawings. It should be noted that components that are the same as the pachinko machine 1 have been given the same reference numerals and a description thereof is omitted. The pachinko machine 1A shown in FIG. 5 is constructed with a projector 71 in place of the projector 31 of the pachinko machine 1. As shown in FIG. 5, the projector 71 is a single-plate type projector (a projector equipped with a single-plate type modulating optical system) that modulates the red light Lr, the green light Lg, and the blue light Lb using a single LCD light valve 84, and includes light converting units 81r, 81g, 81b (referred to simply as the “light converting unit 81” when no distinction is required), a prism 82, the incident-side polarizing plate 54, the LCD light valve 84, the irradiation-side polarizing plate 56, and the projector lens 43. As shown in FIG. 5, the light converting units 81r, 81g, 81b are respectively composed of the LED unit 51 (the LED units 51r, 51g, 51b), the lens arrays 52, 53, the heat sink 57, and the cooling fan 58, with the light L (the red light Lr, the green light Lg, and the blue light Lb) that has been emitted from the LED unit 51, being converted to parallel light by the lens arrays 52, 53 and emitted to the prism 82.

In this case, in the projector 71, the respective LED units 51 (the LEDs 61) flash with a short cycle in a predetermined order in accordance with control by the display control unit 12. As a specific example, the LED unit 51r flashes first, the LED unit 51g flashes second, and the LED unit 51b flashes third, with the respective LED units 51 thereafter repeatedly flashing in that order. Accordingly, the light L is emitted from the light converting units 81r, 81g, and 81b in that order in short cycles. The prism 82 emits the light L emitted from the respective light converting units 81 towards the LCD light valve 84. The LCD light valve 84 is disposed on the emission side of the prism 82 for the light L, and modulates the light L, which has passed the prism 82 and the incident-side polarizing plate 54, based on the display image data Dg.

In the pachinko machine 1A equipped with this projector 71, in the same way as the operation of the pachinko machine 1 described above, the main control unit 3 outputs the command C for displaying the various types of image G and the display control unit 12 carries out the image display process, thereby outputting the display image data Dg. On the other hand, in the projector 71, the light converting units 81r, 81g, 81b emit the red light Lr, the green light Lg, and the blue light Lb in that order in short cycles. In addition, the prism 82 successively emits the red light Lr, the green light Lg, and the blue light Lb emitted by the light converting units 81r, 81g, and 81b towards the incident-side polarizing plate 54, with the incident-side polarizing plate 54 linearly polarizing the respective components of the light L. After this, the LCD light valve 84 successively modulates the respective components of the light L in synchronization with the emission cycles of the respective components of the light L and in accordance with control by the display control unit 12. More specifically, the LCD light valve 84 first modulates the red light Lr based on the red image data in the display image data Dg. Next, the LCD light valve 84 modulates the green light Lg based on the green image data in the display image data Dg. After this, the LCD light valve 84 modulates the blue light Lb based on the blue image data in the display image data Dg. After this, in the same way, the LCD light valve 84 repeatedly modulates the respective components of the light L. The irradiation-side polarizing plate 56 emits and aligns the light L modulated by the LCD light valve 84 in the amplitude direction, and the projector lens 43 magnifies the light L.

Next, the light L that has been magnified by the projector lens 43 is reflected by the mirror 33, converted to parallel light by the Fresnel lens 34, and is then projected onto the screen film 32. At this time, a red image based on the red light Lr, a green image based on the green light Lg, and a blue image based on the blue light Lb are successively formed in order by the screen film 32 with a short cycle and are displayed on the game board 21. In this case, since the respective images are interchangeably displayed in a short cycle, the image G is recognized in color (a color display is achieved). In this way, according to pachinko machine 1A, without providing a plurality of (i.e., three) expensive LCD light valves, red light Lr, green light Lg, and blue light Lb can be modulated using a single LCD light valve 84 to realize a color display of the image G, so that the projector 71 and the pachinko machine 1A can be constructed cheaply.

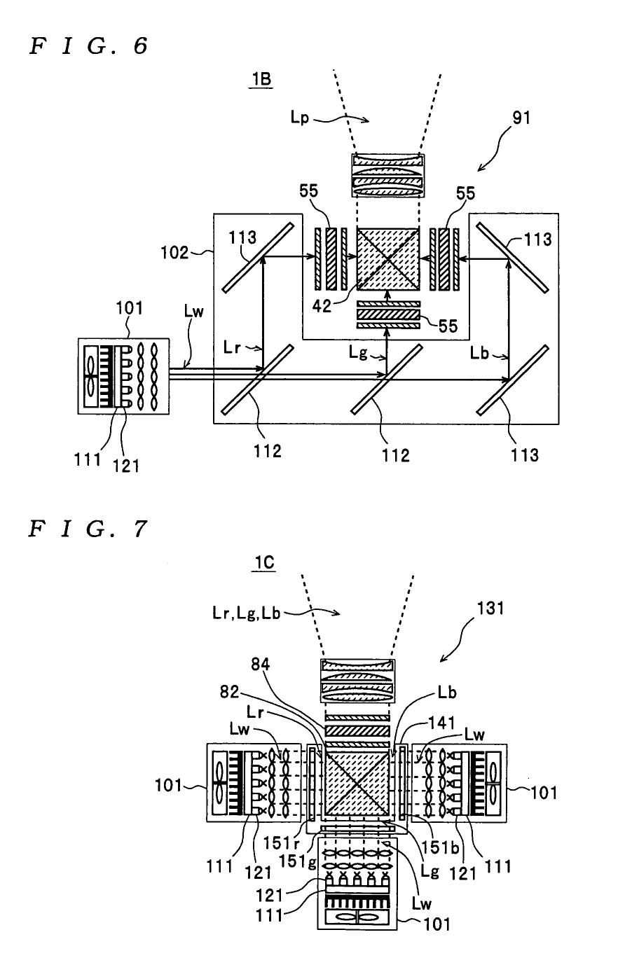

It should be noted that the present invention is not limited to the above construction. For example while an example that uses three LED units 51r, 51g, 51b, on which red LEDs 61r, green LEDs 61g, and blue LEDs 61b are respectively arranged, as light sources, has been described, in place of the LED units 51r, 51g, 51b, as shown in FIGS. 6 and 7, it is also possible to use an LED unit 111 in which white LEDs 121 that emit white light Lw are arranged, so that it is possible to construct a triple-plate type projector and a single-plate type projector using this LED unit 111 as the light source.

As one example, the pachinko machine 1B may include a three-plate type projector 91 that uses the LED unit 111 as a light source. In this case, the projector 91 is composed of parts such as a light converting unit 101 including the LED unit 111, a light separating optical system that is constructed of dichroic mirrors 112, reflection mirrors 113, and the like, and is capable of separating the white light Lw into the red light Lr, the green light Lg, and the blue light Lb, and the three LCD light valves 55, 55, 55. In the pachinko machine 1b equipped with this projector 91, the white light Lw emitted from the LED unit 111 is separated into the red light Lr, the green light Lg, and the blue light Lb by the light separating optical system 102, and the resulting light components are respectively guided to the LCD light valves 55, 55, 55. Next, in the same way as the pachinko machine 1 equipped with the projector 31, the projection light Lp is projected so that the image G is displayed on the game board 21. According to this pachinko machine 1B, since there is only one LED unit 111, it is easy to control the emitted amount of light, so that the brightness, for example, of the image G can be easily adjusted. Also, since the red light Lr, the green light Lg, and the blue light Lb are separately modulated by the three LCD light valves 55, 55, 55, the image G can be displayed with high image quality.

The pachinko machine 1C shown in FIG. 7 includes a single-plate type projector 131 that uses the LED unit 111 as a light source. In this case, the projector 131 is composed of three light converting units 101, 101, 101, a light separating optical system 141 that is constructed of three dichroic filters 151r, 151g, 151b that separate (transmit) the red light Lr, the green light Lg, and the blue light Lb from the white light Lw, and the single LCD light valve 84. The pachinko machine 1C equipped with this projector 131 has the white light Lw successively outputted in short cycles by the respective LED units 111, 111, 111, and the dichroic filters 151r, 151g, 151b separate the white light Lw and successively output the red light Lr, the green light Lg, and the blue light Lb. Next, in synchronization with these emission cycles, the LCD light valve 84 successively modulates the respective components of the light L. In the same way as the pachinko machine 1A equipped with the projector 71, the red light Lr, the green light Lg, and the blue light Lb are projected in short cycles and the image G is displayed in color on the game board 21. According to this pachinko machine 1C, a color display of the image G is achieved with a single LCD light valve 84, so that the projector 131 and the pachinko machine 1C can be constructed at a considerably low cost.

It is also possible to use a projector equipped, in place of the three light converting units 81r, 81g, 81b and the prism 82 of the projector 71, with a single light converting unit including an LED unit in which the red LEDs 61r, the green LEDs 61g, and the blue LEDs 61b are arranged on a single substrate. In this case, in the same way as the projector 71, the red LEDs 61r, the green LEDs 61g, and the blue LEDs 61b in this projector successively flash with a short cycle to respectively emit the red light Lr, the green light Lg, and the blue light Lb, with the LCD light valve 84 successively modulating the respective components of the light L in synchronization with the emission cycles of these components of the light L. By doing so, the image G can be displayed in color.

In addition, although an example where transmissive LCD light valves 55, 84 that modulate the light L by transmitting the light L are used as the light modulating elements has been described, it is possible to use reflective light modulating elements in place of the LCD light valves 55, 84. Also, although an example that uses the lens arrays 52, 53 as a means for converting the light L to parallel light has been described above, the present invention is not limited to this and it is also possible to use a collimator lens or a rod integrator, for example. It is also possible to use a combination of such. In addition, the usage efficiency of light can be improved using a polarizing conversion element. In addition, although an example where LEDs are used as a solid-state light source has been described, the solid-state light source for the present invention includes various kinds of semiconductor light sources, such as a semiconductor laser.

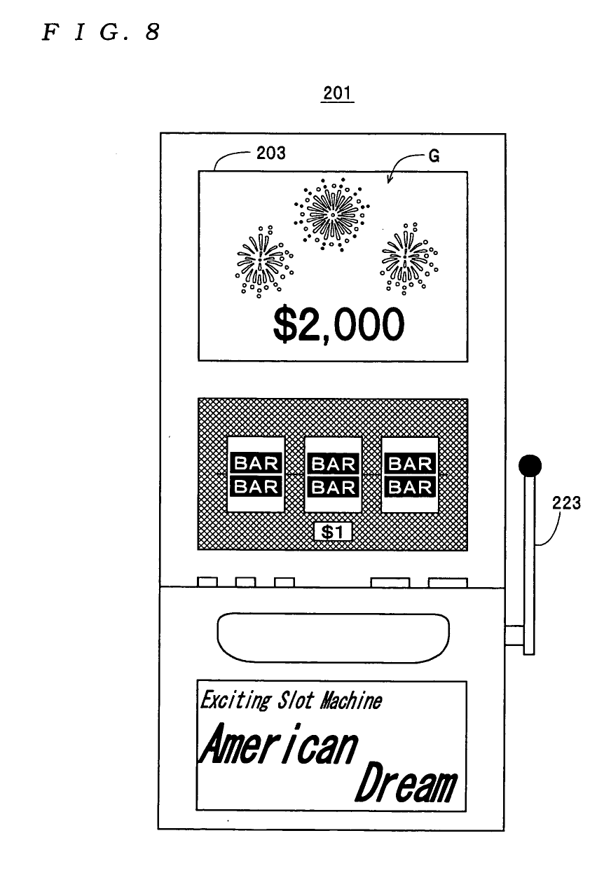

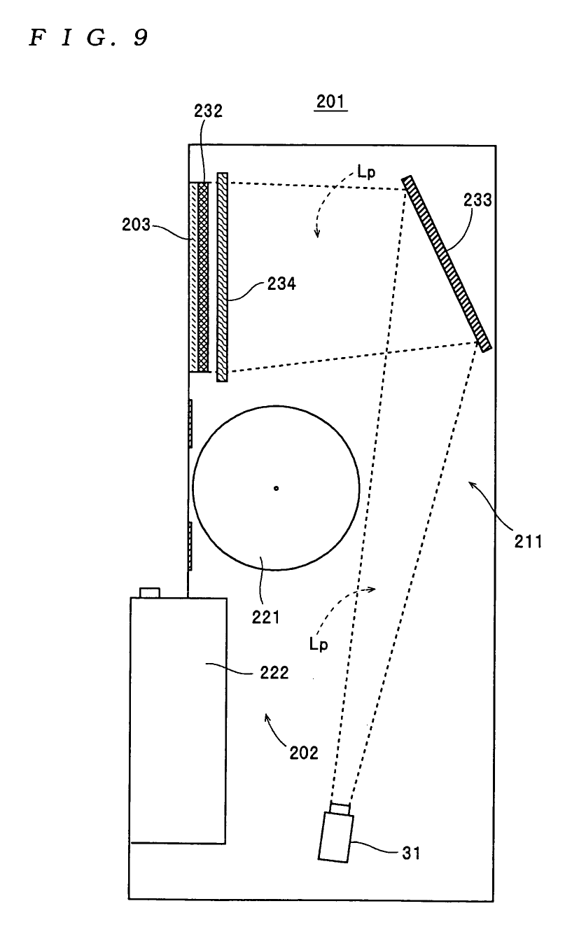

Also, the game machine according to the present invention is not limited to a pachinko machine and also may include a slot machine. As one example, a slot machine 201 shown in FIGS. 8 and 9 is composed of a game mechanism 202 disposed inside the machine main body and an image display optical part 211, with a display panel 203 that corresponds to the display unit for the present invention being constructed so as to be able to display the image G according to a rear projection method. In this case, the game mechanism 202 is equipped with reels 221 that rotate under the control of the main control unit 3 and a payout mechanism 222 that pays out coins (or medals) under the control of the main control unit 3. In addition, the image display optical part 211 is equipped with the screen film 232 that is fixed onto the display panel 203, the mirror 233, the Fresnel lens 234, and the projector 31.

In this slot machine 201, when a handle 223 (refer to FIG. 8) is operated, the main control unit 3 rotates the reels 221 and also carries out a prize draw. Next, when the user has hit the jackpot, the main control unit 3 stops the reels 221 in a state where three of a predetermined pattern (in the illustrated case, “BAR”) are in a line, and also outputs a command C for displaying an image G for a jackpot performance. In accordance with this, the display control unit 12 executes the image display process described above to output the display image data Dg.

At this time, in the same way as the operation of the pachinko machine 1, the projector 31 modulates the light L emitted from the LED units 51 based on the display image data Dg and emits the projection light Lp. After this, as shown in FIG. 9, the projection light Lp emitted from the projector 31 is reflected by the mirror 233, converted to parallel light by the Fresnel lens 234, and then projected onto the screen film 232. By doing so, the image G formed by the screen film 232 is displayed on the display panel 203.

This slot machine 201 also includes the projector 31 that is equipped with LED units 51, on which the LEDs 61 are disposed, as a light source, so that in the same way as the pachinko machine 1 described above, the replacement cost of the LEDs 61 and the amount of power used by the slot machine 201 can be sufficiently reduced, which makes it possible to considerably reduce the running cost of the slot machine 201. Since it is also possible to considerably reduce the heat dissipated outside the slot machine 201, it is possible to prevent environmental deterioration of a game hall due to a rise in the peripheral temperature of the slot machine 201. In addition, since the image G can be displayed brightly shortly after the power is turned on and the power can be turned back on immediately once the power has been turned off, interruptions in a game due to lamps blowing, inspections, and the like can be reduced.

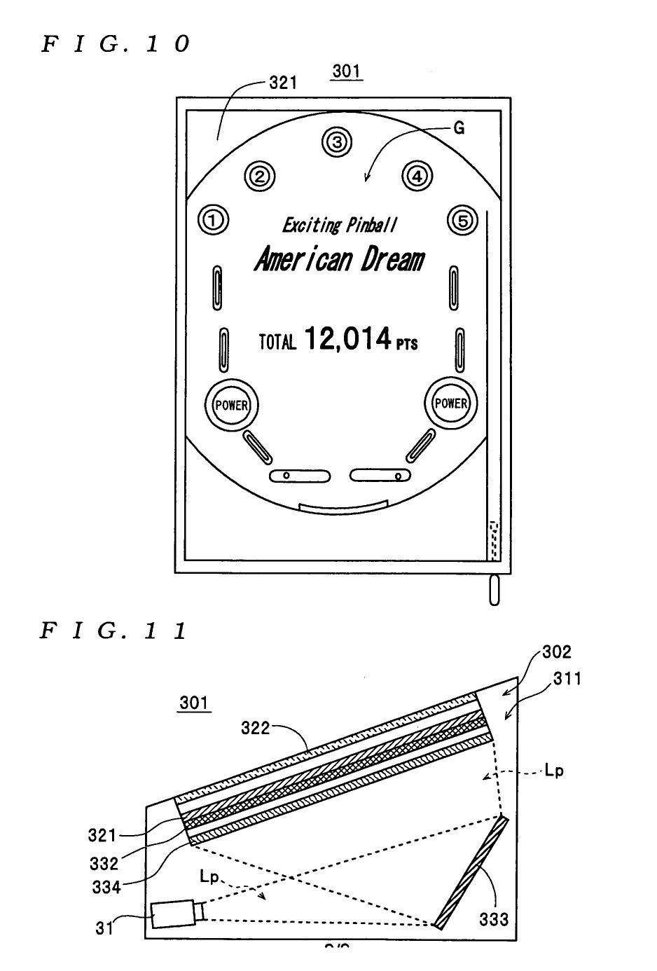

The game machine, according to the present invention, also includes pinball machines. As one example, a pinball machine 301 shown in FIGS. 10 and 11, is composed of a game mechanism 302 and an image display optical part 311. The game mechanism 302 is equipped with a game board 321, which is disposed on an upper surface of the machine main body and also functions as a display unit for the present invention, and a driving mechanism, not shown, that drives various accessories that are disposed on the surface of the game board 321. The image display optical part 311 is equipped with a screen film 332 fixed onto the rear surface of the game board 321, a mirror 333, a Fresnel lens 334, and the projector 31.

In this pinball machine 301, pinball is played by moving a ball in a space between the game board 321 and a glass plate 322 provided on an upper surface of the machine main body. In this pinball machine 301, the main control unit 3 outputs the command C for displaying the image G that includes characters showing a score and the machine name (in this case, “American Dream”) of the pinball machine 301 shown in FIG. 10, with the display control unit 12 carrying out the image display process in accordance with this command C to output the display image data Dg. At this time, the projector 31 modulates the light L emitted from the LED units 51 based on the display image data Dg and projects the projection light Lp to display the image G on the game board 321. This pinball machine 301 is constructed with the projector 31 equipped with the LED units 51, in which the LEDs 61 are arranged, as the light source, so that in the same way as the pachinko machine 1 and the slot machine 201 described above, the running cost of the pinball machine 301 can be considerably reduced, environmental deterioration in a gaming hall due to a rise in the peripheral temperature of the pinball machine 301 can be prevented, and interruptions in a game due to lamps blowing, inspections, and the like can be considerably reduced.

1. A game machine, comprising:
a projector equipped with a light source that emits light for displaying an image; and
a light converting optical system including:
conversion means that converts the light emitted from the light source to approximately parallel light; and
a light modulating element that modulates the converted approximately parallel light,
the projector displaying the image by projecting the modulated light from a rear surface of a display unit,
wherein the light source is equipped with a solid-state light source that emits the light for displaying the image.

2. The game machine according to claim 1, wherein the solid-state light source comprises:
at least one red light emitting diode that emits red light;
at least one green light emitting diode that emits green light; and
at least one blue light emitting diode that emits blue light.

3. The game machine according to claim 2, wherein the light modulating optical system comprises:
a three-plate type modulating optical system including:
a red light modulating element that separately modulates the red light;
a green light modulating element that separately modulates the green light; and
a blue light modulating element that separately modulates the blue light.

4. The game machine according to claim 2, wherein the light modulating optical system comprises:
a single-plate modulating optical system including a single light modulating element that modulates the red light, the green light, and the blue light.

5. The game machine according to claim 1, wherein:
the solid-state light source comprises at least one white light emitting diode that emits white light;
the projector includes a light separating optical system that separates the white light into red light, green light, and blue light, and
the light modulating optical system comprises a three-plate type modulating optical system including:
a red light modulating element that separately modulates the red light;
a green light modulating element that separately modulates the green light; and
a blue light modulating element that separately modulates the blue light.

6. The game machine according to claim 1, wherein:
the solid-state light source comprises at least one white light emitting diode that emits white light;
the projector includes a light separating optical system that separates the white light into red light, green light, and blue light; and
the light modulating optical system comprises a single-plate type modulating optical system including a single light modulating element that modulates the red light, the green light, and the blue light.

7. The game machine according to claim 1, wherein the conversion means comprises:
at least one of a lens array, a collimator lens, and a rod integrator.

8. The game machine according to claim 1, wherein:
the projector includes a heat radiating plate that radiates heat generated by the solid-state light source.

9. The game machine according to claim 1, wherein:
the projector includes an air circulating fan that cools the solid-state light source.
